(19) United States
(12) Patent Application Publication
(10) Pub. No.: US 2010/0288036 A1
(43) Pub. Date: Nov. 18, 2010

(54) DEVICE FOR DETERMINING THE POSITION OF A PISTON IN A CYLINDER

(75) Inventor: Thomas Volkwein, Pliening (DE)

Correspondence Address: D. PETER HOCHBERG CO. L.P.A., 1940 EAST 6TH STREET, CLEVELAND, OH, 44114, US

(73) Assignee: Truma Geratetechnik GmbH & Co. KG, Putzbrunn (DE)

(21) Appl. No.: 12/452,869

(22) PCT Filed: Jun. 27, 2008
(86) PCT No.: PCT/EP2008/005283

§ 371 Date: Apr. 19, 2010

(30) Foreign Application Priority Data
Jul. 27, 2007 (DE) 102007035252.4

(51) Int. Cl. G01M 15/06

(52) U.S. Cl. 73/114.29

(57) ABSTRACT

A device for determining the position of a piston in a cylinder comprises an ultrasound facility for transmitting ultrasound signals into the inside of the cylinder and for receiving ultrasound signals that are reflected from said piston. A projection is provided on a front surface of the piston and comprises a front surface that is offset by a certain height with respect to the remaining front surface of the piston. The projection is isolated in any piston position that can be reached during operation. The position of the piston is determined by an analytical facility based on the transit time of the ultrasound signals between the ultrasound facility and the front surface of the projection.

This application is a National Stage application of International Application No. PCT/EP2008/005283, filed on Jun. 27, 2008 and claims priority of German Application Serial No. DE 10 2007 035 252.4 filed Jul. 27, 2007.

### BACKGROUND OF THE INVENTION

1. Field of the Invention

The invention relates to a device for determining the position of a piston in a cylinder through the use of ultrasound signals.

2. Description of the Prior Art

An ultrasound position measuring system is known from DE 103 22 178 A1, in which an ultrasound transducer transmits ultrasound signals into a cylinder in the direction of a front surface of a piston and receives the ultrasound signals that are reflected from there. The distance of the front surface of the piston from the ultrasound transducer and thus the position of the piston within the cylinder can be determined based on the transit time of the ultrasound signals, provided the velocity of sound in the medium is known.

A similar system is described in U.S. Pat. No. 4,543,649, whereby a step is provided at the relevant front surface of the piston and a part-chamber, into which the step can penetrate shortly before the piston reaches the end-position, is allocated to said step opposite on the front surface of the cylinder. This effects an end-position damping of the motion of the piston in order to prevent the piston from hitting too hard against the front-side stop.

FIG. 1 shows the structural principle of a known piston-cylinder unit, in which the position of the piston is detected by means of ultrasound signals.

On the inside of a cylinder 1, a piston 2 is axially mobile and is additionally guided by means of a piston rod 3 that is guided from cylinder 1 on the front side. Opposite from a front surface 4 of the piston 2, an ultrasound facility 5 that comprises an ultrasound transducer 6 is arranged at a front-side end of the cylinder 1. The ultrasound transducer 6 serves for transmitting ultrasound signals in the direction of the front surface 4 and for receiving the ultrasound signals reflected from the front surface 4.

The ultrasound transducer 6 is connected to an analytical facility 7 that determines the distance of the front surface 4 from the ultrasound transducer 6 and thus the position of the piston 2 in the cylinder 1 based on the transit time of the ultrasound signals and by means of a velocity of sound of the ultrasound in a medium that fills a main chamber 8 that is enclosed by the cylinder 1 and the piston 2.

The velocity of sound depends on the medium, the temperature, and the pressure, and changes during the operation of the piston-cylinder unit. For this purpose, as has also been described in DE 103 22 718 A1, a reference surface 9 having a predetermined distance 10 from the ultrasound transducer 6 is arranged upstream of the ultrasound transducer 6. Based on the transit time of the ultrasound signals between the ultrasound transducer 6 and the reference surface 9 and by means of the known distance 10, the analytical facility 7 can determine the actual velocity of sound at all times. The medium can be, e.g., hydraulic oil or any other suitable fluid such as, e.g., a liquid or a gas.

The fluid may be supplied to the main chamber 8 and/or removed therefrom by means of a line 11 in order to change the position of the piston 2.

In addition, a second main chamber 12 can be provided on the back side of the front surface 4 of the piston 2, i.e. on the side of the piston rod 3, and the medium can also be supplied to the main chamber 12 by means of a line 13. This allows the force acting on the piston 2 to be increased and/or returning forces can be generated that move the piston 2, e.g. toward the left in FIG. 1.

It has been evident that the ultrasound signal can occasionally be disturbed due to interference or scattering effects that render precise determination of the position of the piston 2 more difficult.

It is desirable that the ultrasound signals emitted by the ultrasound transducer 6 proceed along a main direction 14 in the cylinder 1 that corresponds to a main axis of the cylinder 1, and impinge perpendicularly on the front surface 4 of the piston 2. Due to, e.g., scattering effects, it is inevitable that ultrasound signal portions proceeding obliquely to the main direction 14, i.e., e.g., along a minor direction 15, are generated as well. These signal portions generate interfering signals that may superimpose on the ultrasound signal that is reflected directly from the front surface 4. Therefore, the signal portions of the different paths 14, 15 taken by the signals along the internal wall of the cylinder 1 and the front surface 4 of the piston 2 may show interference, in particular, at the location of the ultrasound transducer 6. This leads to distortion, amplification or partial extinction of the signal received at the ultrasound transducer 6. Since there are multiple possibilities of signal propagation over the tube wall that have different path lengths in the tube of the cylinder 1, the received signals are also prolonged and/or shifted. The difference between the received signals renders it more difficult to measure the transit time of the ultrasound signal along the main direction 14 precisely.

FIG. 2 shows typical amplitudes of received signals that reach the ultrasound transducer 6 in the form of echo signals. In this context, FIG. 2A shows an approximately ideal received signal, whereas FIG. 2B shows a received signal in the presence of interference.

Due to the physical properties of the ultrasound transducer 6, a transmitted pulse increases in amplitude over the course of several oscillation periods, e.g. over the course of three to five periods and/or half-waves. The transmitted signal is not shown in FIG. 2 and would have to be shown to the far left on the time axis. The received signal comprises a corresponding number of half-waves that are increasing in amplitude, e.g. five in FIG. 2A. The rise of the signal is characterized by a curve 16. The start of the signal rise is marked by reference number 17. After the main signal that is shown in FIG. 2A and characterized by curve 16 follow less intense signal echoes that can originate from disturbances.

In order to determine the transit time of an ultrasound pulse, the amplitude of the received signal is recorded and/or standardized to a predefined constant amplitude value 18. The signal is monitored by means of a threshold value comparator that is present in the analytical facility 7, and any exceeding of a predefined second level that is marked as threshold 19 is recognized. The time point at which the threshold 19 is exceeded is marked by the reference sign 20A in FIG. 2A.

Downstream from the threshold value comparator in terms of time, there is a zero crossing comparator that precisely detects the transit time of the signal exactly to the next consecutive zero crossing 21A of the signal, for example from negative to positive.

A time period 22A elapses between the actual start of the signal rise (reference number 17) and the zero crossing 21 and should correspond to a predefined signal offset. Accordingly, once the ultrasound transducer 6 determined the signal transit time from transmission of a pulse to the zero crossing 21A of the signal echo, the signal offset time period 22A is subtracted in order to determine the actual transit time of the signal from the start of transmission to the start of the signal rise 17.

In order to maintain the precision of this measurement, it is necessary for the predefined time period 22 to always be the same and/or for the signal echo to be able to comply with it. For this purpose, it is necessary for the threshold value comparator to consistently detect the same defined half-wave (exceeding of the threshold at time point 20) in each measurement. In order for this to be achieved, the curve for the signal rise 16 (leading edge) must always show the same slope over time and be as steep as possible.

However, due to the interference and signal broadening described above, the signal forms vary strongly, as is shown, in particular, in FIG. 2B. The echo signal therein is strongly deformed, especially in its slope over time, and prolonged in time. The time point 20B, at which the threshold value is exceeded, is clearly later as compared to FIG. 2A. Accordingly, the zero crossing 21B is detected significantly later as well. The resulting period of time 22B for the signal offset is significantly longer than the (correct) period of time 22A.

However, since the signal offset that corresponds to the time period 22 must be predefined in the ultrasound transducer 6 and/or the analytical facility 7 and is therefore constant for all measurements, the actual transit time of the ultrasound signal can no longer be determined precisely. As is easily evident, subtraction, for example, of the predefined signal offset time period 22A from the time point of zero crossing 21B would not allow for determination of the actual start of the signal rise 17.

In the presence of strongly varying signal forms, the threshold value comparator would therefore be triggered at different half-waves at different times 20A, 20B, and thus generate an error 23.

The oscillation period of an ultrasound signal of, for example, 1.25 MHz is 800 ns, which corresponds to a wavelength of 1.2 mm for a velocity of sound of the medium of, e.g., 1,500 m/s. It has been evident that the received signal can become deformed so strongly due to the interference mentioned above that the detection of the threshold value comparator becomes incorrect by several, for example five, wavetrains. This corresponds to a distance of 12 mm and/or an inaccuracy in the measurement of piston position amounting to half of the incorrect distance thus measured, i.e. 6 mm.

A motor vehicle pneumatic spring system having an ultrasound measuring set-up is known from EP 1 199 196 A2. The pneumatic spring system essentially consists of a rolling bellows that is closed-off by means of a cover plate on its one end and by means of a rolling piston on its other end. In order to carry out a contact-less distance measurement on the inside of the pneumatic spring, an ultrasound transducer is arranged on the cover plate and a reflector is arranged on the rolling piston. The reflector is provided to be two-stepped, whereby the one step serves as a target reflector and the other step serves as reference reflector.

DE 103 30 914 A1 describes a method for determining a current position of a piston that can be shifted in a cylinder. The piston comprises on its front surface an elevation that extends ring-shaped on the outer edge of the front surface.

JP 59062705 A shows a piston-cylinder unit, in which a recess that is opposite from an ultrasound transducer is provided in the front surface of the piston.

A piston-cylinder unit is known from JP 10238513 A. A stop is provided on the front side of the piston, whereby an ultrasound transducer detects the ultrasound signals that are reflected from the stop.

### SUMMARY OF THE INVENTION

The invention is based on the object to provide a device for determining the position of a piston in a cylinder that can be used for a more precise measurement.

The object is met according to the invention by a device according to the independent claims. Further developments of the invention are specified in the dependent claims.

A device for determining the position of a piston in a cylinder comprises an ultrasound facility for transmitting ultrasound signals into the inside of the cylinder and for receiving ultrasound signals that are reflected from the piston. The signals are guided on the inside of the cylinder in a direction essentially perpendicularly onto a front surface of the piston, and are reflected from there. A projection is provided on the front surface of the piston and comprises a front surface that is offset by a certain height with respect to the remaining front surface of the piston. The front surface of the projection may be situated parallel to the front surface of the piston. However, it must be clearly raised off the remaining front surface of the piston. The front surface of the projection is, in particular, designed such that the projection is isolated in any piston position that can be reached during operation, i.e. a lateral surface of the projection that borders on the front surface of the projection and leads to the front surface of the piston is situated to be free and, in particular, does not immediately border on an internal surface of the cylinder.

Moreover, there is an analytical facility present for analyzing a transit time of the ultrasound signals from the ultrasound facility to the front surface of the projection and back to the ultrasound facility, as well as for determining the position of the piston based on said transit time of the ultrasound signals.

The projection and/or extension that is provided on the front surface of the piston, which is essentially to reflect the ultrasound signals, therefore forms an additional front surface that is offset with respect to the front surface of the remaining piston and is arranged somewhat closer to the ultrasound facility. Since the projection is to be present such as to be isolated in any position of the piston, it cannot become situated in the proximity of an internal surface of the cylinder, e.g. on a stop formed by the cylinder, even in the end-positions of the piston. Rather, the projection forms the separate front surface which, as has been evident, can be identified in the ultrasound echo signal at high accuracy.

Opposite from the raised front surface that is present on the projection, the remaining front surface of the piston is formed appropriately such that a recessed piston surface is produced that borders on the internal tube wall of the cylinder. In this context, the front surface of the projection can be arranged to be parallel and directly opposite an emission surface of the ultrasound facility. In particular, the central axes of the front surface of the projection and of the emission surface can be oriented on a common axis.

What is attained by this arrangement upon appropriate selection of the diameter of the front surface of the projection and its height with respect to the remaining front surface of the piston is that all signal portions that follow, e.g., a sound path in the minor direction, from the ultrasound facility due to the diffraction related opening angle, proceed over the recessed ring surface of the piston and are offset spatially, and therefore temporally also, with respect to the signal portions that follow a main direction, whereby they impinge on the ultrasound facility in a delayed fashion and do not effect interference of the relevant echo signal.

This results in echo signals whose first leading edges are identical, independent of the position of the piston in the cylinder tube. This renders exact detection of the leading edge of an ultrasound signal by means of a threshold value comparator feasible.

The ultrasound facility can comprise an ultrasound transducer for transmission and reception of the ultrasound signals. If applicable, separate facilities can be provided for transmission and reception of the ultrasound signals.

The projection and/or, in particular, the front surface of the projection can be provided to be axially symmetrical to a main axis of the piston.

Accordingly, the projection and/or, in particular, the front surface of the projection can have a circular or a ring-shaped outline on the remaining front surface of the piston.

The projection can be an integral component of the piston or can be secured to the remaining piston as a separate structural component, e.g. by screwing it on. Accordingly, the projection can consist of the same material as the piston or of a different material.

The diameter of the projection can correspond at least to the diameter of an effective transmitting surface of the ultrasound transducer, i.e. of the emitting surface. Thus, the front surface of the projection is sufficiently large for sufficient reflection of ultrasound signals.

The diameter of the projection should correspond at most to an internal diameter of the cylinder that is decisive for guidance of the piston minus the diameter of the transmitting/emitting surface of the ultrasound transducer. In any case, the diameter of the projection should only be such that the projection and/or its front surface is situated at a distance from the internal wall of the cylinder guiding the piston that is sufficient to prevent the interfering echo signals generated in this location.

The height of the projection, namely a distance between the front surface of the projection and the remaining front surface of the piston, can correspond at least to half of a rise time of the ultrasound signal multiplied by the maximal possible velocity of sound in a medium that is enclosed by the piston and the cylinder. If this condition is met, the pulses reflected from the front surface of the projection are ensured to reach the ultrasound transducer in due time to be ahead of other echo signals such that, by this means, they cannot be disturbed by interference or other effects. If the projection is smaller, i.e. in the presence of a smaller distance between the front surfaces of the projection and the piston, respectively, clean separation of the signals is no longer possible without further effort.

There is no upper limit on the height of the projection from the point of view of physics. However, it is desirable not to increase the installation space unnecessarily without further benefit by extending the piston and the cylinder.

A stop can be provided on the inside of the cylinder for stopping the remaining front surface of the piston and thus for defining an end-position for the piston. The stop can be designed such that, when the piston is in its end-position, the part of the remaining front surface of the piston that does not touch the stop contacts the medium. Accordingly, the projection is completely surrounded by the medium even in the end-position, in which a part of the front surface of the piston rests against the stop, such that ultrasound signals that are reflected from the projection can be received and processed even in this position. Accordingly, the projection is to be present to be isolated in this piston position as well and its effect shall not be negated by resting against a stop surface.

The medium can be a common fluid, e.g. hydraulic oil, water or gas (air).

With the piston being situated in the end-position, it can be useful to have an annular gap between the projection of the piston and the stop of the cylinder, with the annular gap being bordered on one side by a part of the front surface of the piston. The annular gap allows for a clear structural separation between the projection and/or the front surface of the projection on one hand, and the stop that belongs to the cylinder on the other hand, in order to be able to detect echo signals that are reflected accordingly.

The ultrasound facility can be an axial ultrasound facility and can be arranged on a front-side end of the cylinder. The ultrasound signals are then transmitted into the cylinder by the ultrasound transducer essentially axially along the main direction.

However, the ultrasound facility can just as well comprise a deflecting facility for deflecting the ultrasound signals transmitted by the ultrasound transducer toward the front surface of the piston and/or for deflecting the ultrasound signals reflected from the front surface of the piston back to the ultrasound transducer. In this context, front surface of the piston shall always be understood to mean the entire front surface, i.e. including the front surface of the projection on the piston. Accordingly, the deflecting facility ensures that the ultrasound signals do not need to be guided in a straight line from the ultrasound transducer to the front side of the piston, but rather can experience a deflection in at least one location.

The ultrasound facility can be a transverse ultrasound facility and can be arranged on the side of the cylinder. The ultrasound signals are then transmitted into the cylinder by the ultrasound transducer essentially transversely to a main axis direction of the cylinder and deflected by the deflecting facility by an angle of, e.g., 90°, in the direction of the piston. This arrangement enables not placing the ultrasound facility at the front-side end along the cylinder, but rather laterally, e.g. on a jacket surface of the cylinder, whereby the ultrasound signals are then deflected on the inside of the cylinder in order to impinge perpendicularly on the piston in common fashion.

The piston can be connected to a piston rod that is guided axially from the cylinder on a front-side end. The axial ultrasound facility can be arranged on the front-side end of the cylinder at which the piston rod is not guided out, whereas the transverse ultrasound facility is provided in an area of the front-side end of the cylinder, at which the piston rod is guided out. By this means, the position of the piston can be detected simultaneously from both sides and can therefore be determined at higher accuracy. The transverse ultrasound facility allows ultrasound to also be guided-in on the side of the piston that is already largely filled by the piston rod. Moreover, the measuring range, namely the measuring length, can be increased and/or a redundancy of the measuring systems can be attained for increased safety requirements.

The piston can be axially mobile in a main chamber of the cylinder and comprise on its front surface a step on which, in turn, the projection is formed. In corresponding fashion, a part-chamber that borders on the front side on the main chamber can be provided in the cylinder, with the internal layout of the part-chamber being designed such that the step can penetrate at least partially into the part-chamber and such that the part-chamber thereby becomes separated from the main chamber by the step. This means, though, that the step may initially be similar in shape to the projection and project from the remaining front surface of the piston. However, the step is not present such as to be isolated in all operating positions of the piston, but rather can penetrate into the part-chamber in a largely perfectly fitting fashion shortly before an end-position is reached and, in the course, essentially separates the part-chamber from the main chamber—except for a grease film. In this context, the step contacts the part-chamber and/or only a very small gap remains between the step and the wall of the part-chamber. This allows an end-position damping to be achieved for the piston when the fluid enclosed in the part-chamber can exit from the part-chamber only slowly.

In contrast, even when the step has penetrated into the part-chamber, the projection remains present such as to be isolated such that the projection continues to be situated freely on the piston and/or the step.

The ultrasound facility can comprise a reference surface whose distance to the ultrasound transducer is predefined. A velocity of sound in the medium can be determined by means of the analytical facility and based on the transit time of an ultrasound signal between the ultrasound transducer and the reference surface, such as is described, e.g., in DE 103 22 718 A1. Accordingly, the analytical facility can always determine the current velocity of sound based on the transit time to the reference surface, even if the velocity of sound changes, e.g. by changes of the temperature or pressure of the medium, or by changes of the medium itself. This allows a high measuring accuracy to be attained even in the presence of changing measuring conditions.

The reference surface and the ultrasound transducer may form a structural unit.

It is feasible just as well for the reference surface to be integrated into the deflecting facility, provided one is present.

Another device for determining the position of a piston in a cylinder also comprises an ultrasound facility, whereby a deflecting facility is present on the ultrasound facility for deflecting the ultrasound signals transmitted by the ultrasound facility toward the front surface of the piston or for deflecting the ultrasound signals reflected from the front surface of the piston back to the ultrasound facility.

This device provides a good supplement to the device described above, in which the front surface of the piston carries a projection. The ultrasound facility being equipped with a deflecting facility does not necessitate the presence of a projection of this type on the piston when the device is used, in particular, on the piston rod-side of a cylinder. In this place, the space between piston and cylinder is largely filled by the piston rod such that only a relatively small annular space remains for the medium and, thus, for the ultrasound signals between the internal wall of the cylinder, the back-side front side of the piston, and the piston rod. It has been evident that the interference effects in a space that is this small are less pronounced and therefore tolerable.

### BRIEF DESCRIPTION OF THE DRAWINGS

These and further advantages and features of the invention are illustrated in detail in the following by means of examples and aided by the accompanying figures. In the figures:

FIG. 1 shows a schematic view through a known piston-cylinder unit having an ultrasound facility;

FIG. 2 shows received ultrasound signals with undisturbed reception (FIG. 2A) and disturbed reception (FIG. 2B);

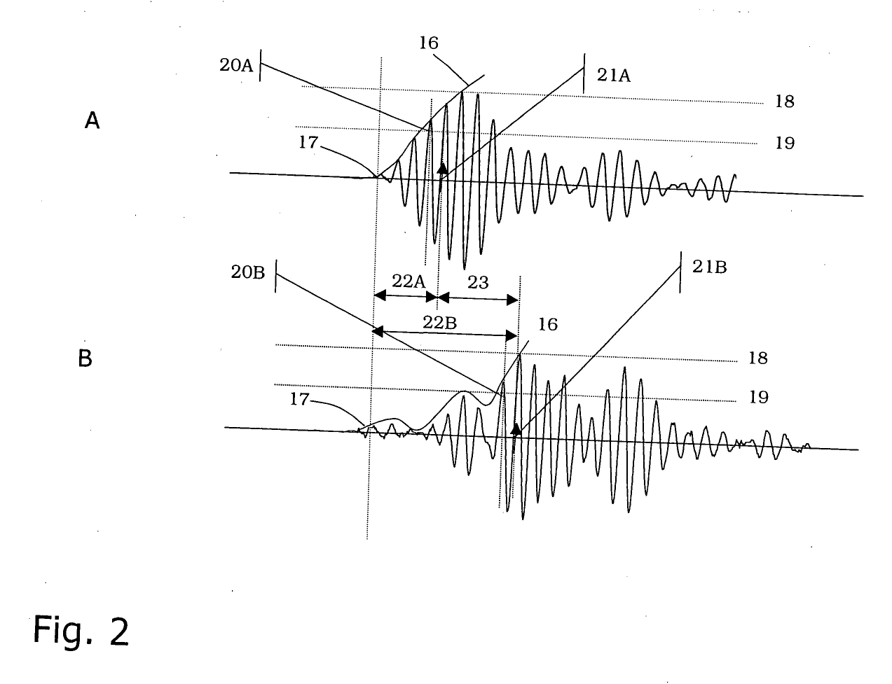

FIG. 3 shows a piston-cylinder unit having an ultrasound facility;

FIG. 4 shows time courses of echo signals;

FIG. 5 shows another embodiment of a piston-cylinder unit having an ultrasound facility;

FIG. 6 shows yet another embodiment of a piston-cylinder unit; and

FIG. 7 shows yet another embodiment of a piston-cylinder unit.

### DETAILED DESCRIPTION OF THE PREFERRED EMBODIMENTS

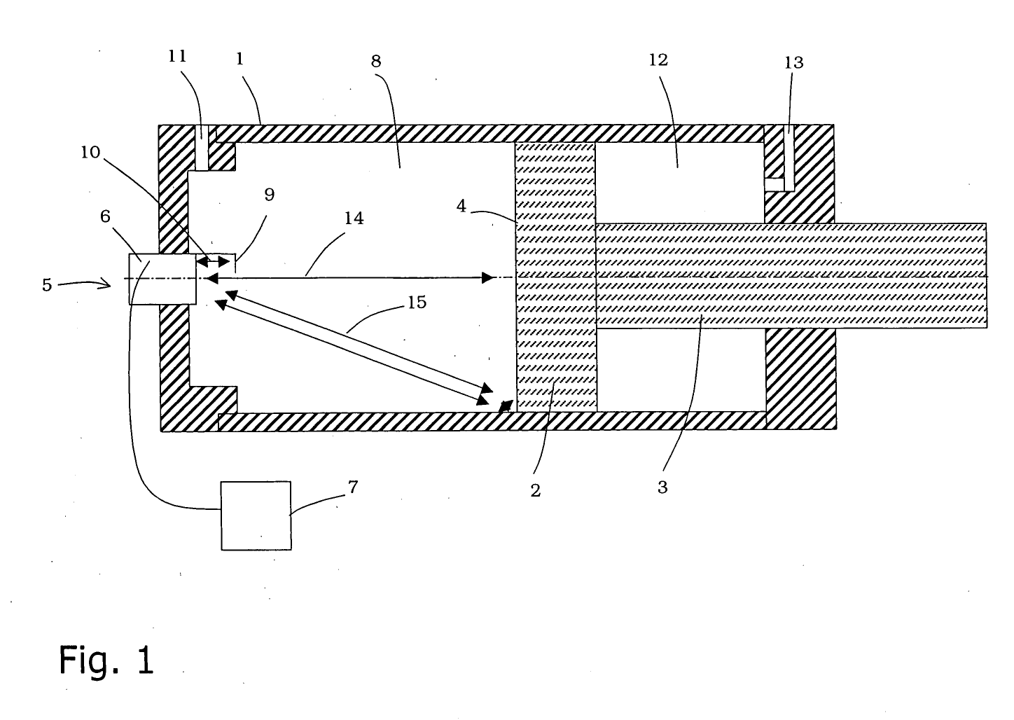

A known piston-cylinder unit having an ultrasound measuring device has already been described above based on FIG. 1. Therefore, in as far as identical or similar structural elements are used in the embodiments described in the following, the same reference numbers as in FIG. 1 are used.

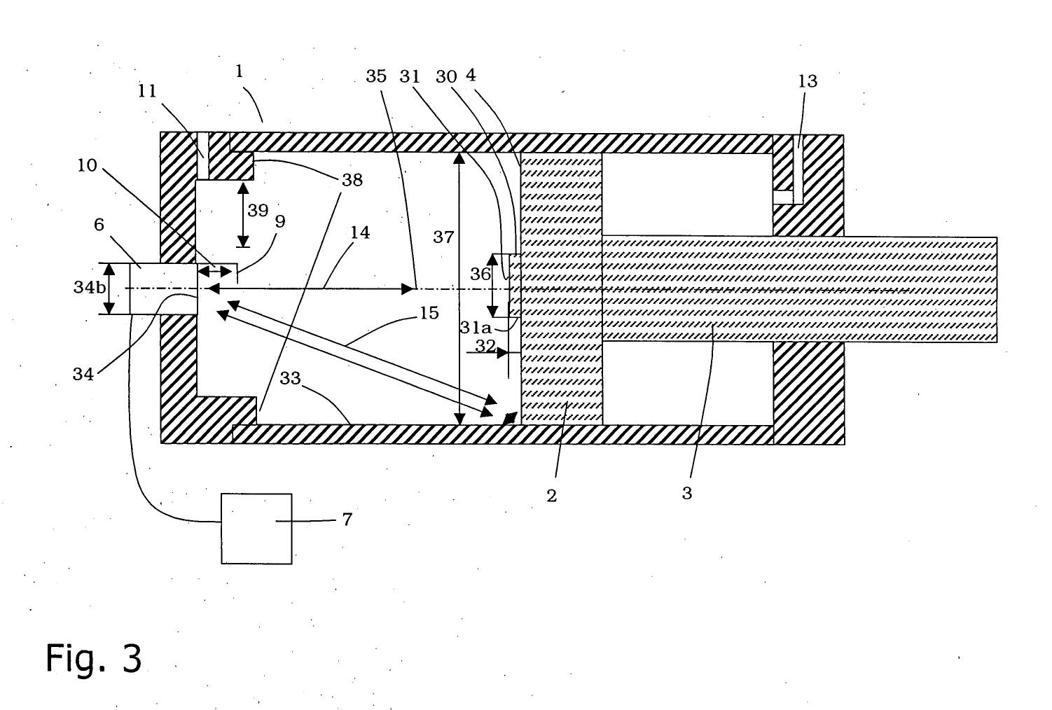

In the embodiment of a piston-cylinder unit shown in FIG. 3, a projection 30 is provided on a front surface 4 of a piston 2 that faces an ultrasound transducer 6. The projection 30 comprises a front surface 31 that is raised by a distance and/or a height 32 from the remaining front surface 4 of the piston 2. A cylinder-shaped lateral surface 31a extends from the front surface 31 to the remaining front surface 4 of the piston 2. The projection 30 thus forms a wart on the piston 2.

The remaining front surface 4 of the piston 2 borders on an internal wall 33 of the cylinder 1 and is axially recessed with respect to the front surface 31 of the projection 30.

The front surface 31 of the projection 30 is arranged parallel to and directly opposite from a transmitting and/or emitting surface 34 of the ultrasound transducer 6. Accordingly, the central axes of the front surface 31 and the emitting surface 34 are arranged on a common axis 35, which simultaneously corresponds to the main axis of the cylinder 1 and/or the piston 2 in the example shown. The emitting surface 34 can have a diameter between 6 and 20 mm.

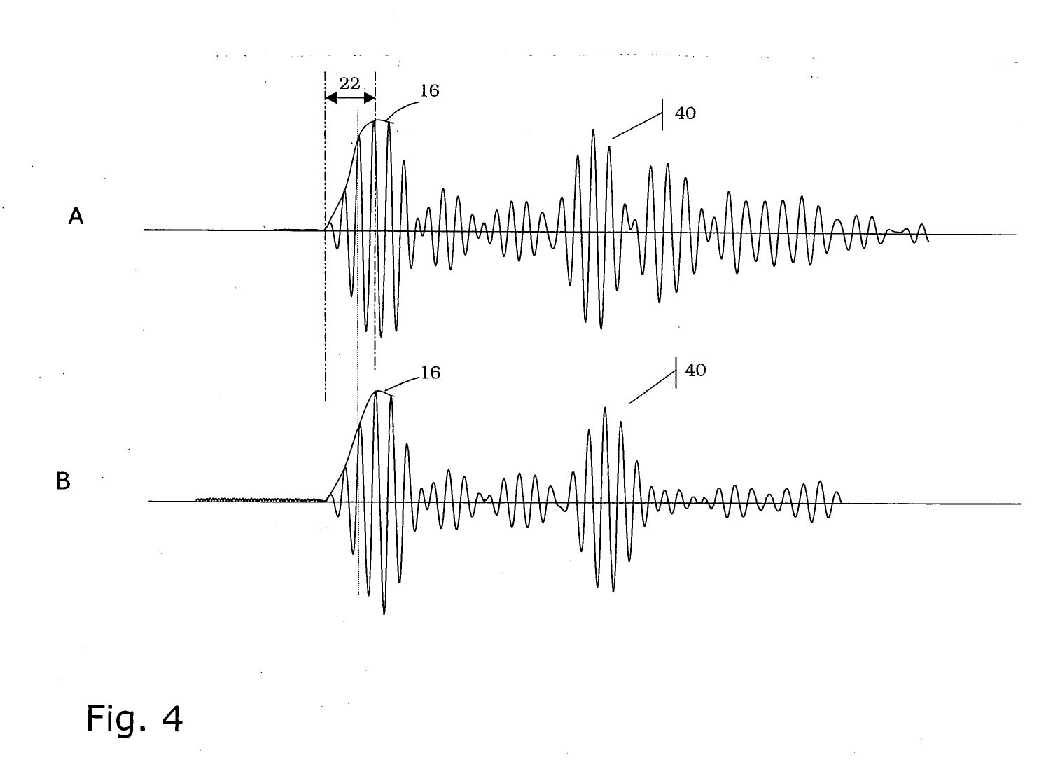

What is attained with said arrangement and appropriate selection of a diameter 36 of the front surface 31 and height 32 of the front surface 31 is that the signal portions that follow the sound path from the ultrasound transducer 6 along the minor direction 15 due to the diffraction-related opening angle, proceed via the ring-shaped front surface 4 of the piston 2 and are offset spatially, and therefore temporally also, with respect to the signal portions that follow the main direction 14, which causes the echo signals to impinge on the ultrasound transducer 6 in a delayed fashion such that there is no interference in the area of the signal rise. This results in echo signals whose first leading edge is independent of the position of the piston 2 in the cylinder 1, as shall be illustrated below by means of FIG. 4. This facilitates exact detection of the leading edge of the ultrasound signal using a threshold value comparator.

The diameter 36 of the front surface 31 should correspond at least to a diameter 34b of the emitting surface 34 of the ultrasound transducer 6 such that no useful signal portions proceeding back and forth between the ultrasound transducer 6 and the projection 30 are lost.

On the other hand, the diameter 36 of the projection 30 should correspond at most to an internal diameter 37 of the cylinder 1, i.e. of the internal wall 33, minus the diameter of the emitting surface 34 of the ultrasound transducer 6, since signal portions following the minor direction 15 would otherwise proceed vie the projection 30 again and cause the interference described above.

The distance and/or the height 32 of the front surface 31 of the projection 30 with respect to the remaining front surface 4 of the piston 2 shall correspond to at least half of the rise time of the ultrasound signal multiplied by the maximal velocity of sound in the medium. If the leading edge of the ultrasound signal extends, for example, over the duration of four periods, the resulting minimal required height 32 of the projection 30 for a wavelength of 1.2 mm (at a signal frequency of 1.25 MHz and a velocity of sound of 1,500 m/s) is (4*1.2 mm)/2=4.8 mm/2=2.4 mm. A height 32 of, e.g. 3 mm, would therefore be fully sufficient.

According to FIG. 3, a ring-shaped stop 38 against which the front surface 4 of the piston 2 can hit is provided on the internal wall 33 of the cylinder 1.

What said design of the stop 38 attains is that an annular gap having a width 39 remains between the projection 30 and the ring-shaped stop 38, and this occurs even when the piston 2 touches against the stop 38. The annular gap 39 ensures that the medium, for example hydraulic oil, can always flow unimpeded to the line 11. On the other hand, the annular gap 39 also ensures that the projection 30 remains isolated, i.e. does not extend into the vicinity of the internal wall 33 of the cylinder 1. In the absence of the annular gap 39, there would be a risk of interference as described above.

FIG. 4 shows echo signals for two different piston positions in the cylinder 1 (FIG. 4A and FIG. 4B). It is clearly evident that the signal rise 16 is virtually identical independent of piston position. The respective offset period 22 is not different either. The frequency of the ultrasound signal can, e.g., be between 300 kHz and 3 MHz.

In the further time course of the ultrasound signals, signal portions 40 are recognizable that originate from signals that followed sound paths via the minor directions 15 and now arrive temporally offset relative to the first leading edge 16. Said signal portions 40 can be distinguished clearly from the signal portions of the signal rise 16 that are relevant for the transit time such that exact detection of the ultrasound signal is made feasible.

The projection 30 and/or the front surface 31 carried by the projection 30 is provided to be circular in the embodiment shown in FIG. 3.

When the distance between the piston 2 and the signal transducer 6 increases, the signal portions reflected from the remaining front surface 4 of the piston 2 increase relatively more strongly than those from the front surface 31 of the projection 30. Accordingly, it is possible that the first rise signal that is characterized by the signal rise 16 may become smaller than, e.g., the signal portions 40 that can be reflected, inter alia, from the front surface 4 of the piston 2. In order to still render precise detection of the then relatively less intense signal portion at signal rise 16 in this case, the more intense signal portion 40 is used for rough detection of the position of piston 2. In this context, it is presumed that the signal rise 16 from the front surface 31 of the projection 30 is detected several periods earlier at the signal transducer 6 such that the whole echo signal can be analyzed accordingly. In particular, starting from the reception of the signal portion 40, it can be checked whether or not an earlier less intense signal rise 16 can be detected.

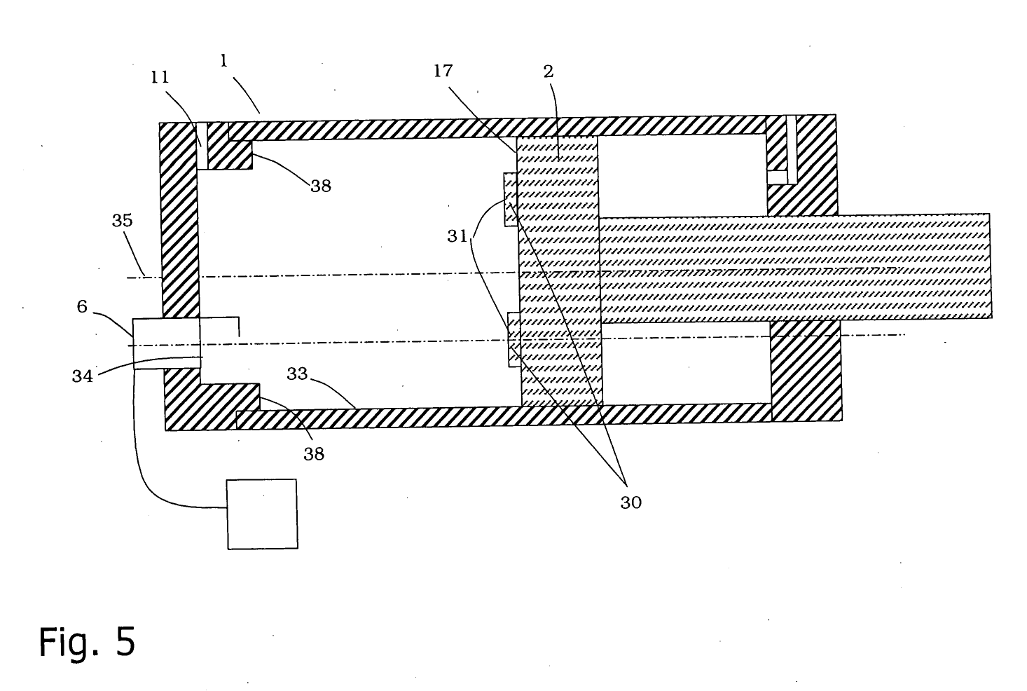

FIG. 5 shows a similar arrangement as FIG. 3, in which the projection 30 is designed to be circular ring-shaped, though, and the front surface 31 therefore also has a circular ring shape. Accordingly, the projection 30 and/or the front surface 31 form a concentric ring around the main axis 35 of the cylinder 1.

The ultrasound transducer 6 is arranged eccentric with respect to the main axis 35 and placed such that its circular emission surface 34 is situated opposite from a part of the front surface 31 of the projection 30. By this means, a corresponding raised reflection surface is always situated opposite from the ultrasound transducer 6 independent of the rotational orientation of the piston 2. This can make sense, for example, when there is no space for positioning the ultrasound transducer 6 in central position of the main axis 35.

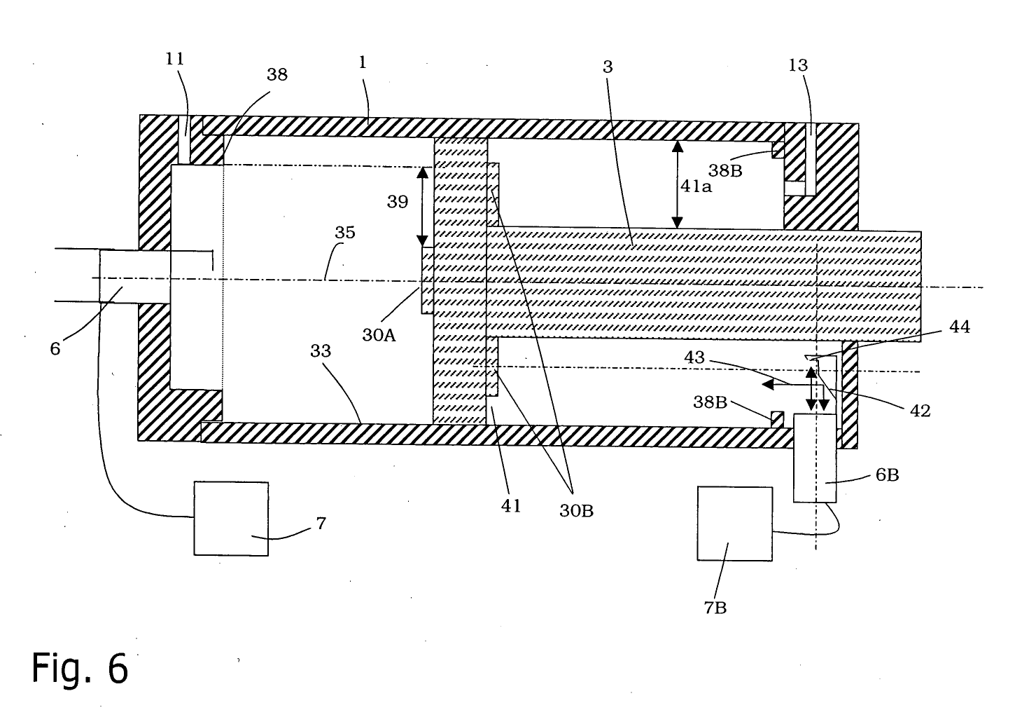

As shown in FIG. 5, the ring-shaped front surface 31 having the projection 30 can be provided on the piston side. FIG. 6 shows an alternative, in which the ring-shaped front surface 31 is attached on the so-called “rod side”, i.e. on the side of the piston rod 3. For distinguishing the projection on the piston side (reference number 30A in FIG. 6), the rod-side projection is denoted by reference number 30B.

In the assembly of an ultrasound transducer on the side of the piston rod 3 shown in FIG. 6, it is advantageous, for structural reasons, for the projection 30B that is formed by a concentric ring to be radially bordered on the inside by the piston rod 3. Only on the outside there should be an annular gap 41 in order to attain the desired delimitation from the internal wall of the cylinder 1.

A further ring-shaped stop 38B that corresponds to the stop 38 illustrated above is provided on the rod side.

Assembly on the side of the piston rod 3 may be required, for example, in synchronous cylinders which are fitted with a mobile piston rod 3 on both sides such that only extra-axial assembly of the ultrasound transducer 6 is feasible.

In most cases, there is not much assembly space available on the side of the piston rod 3 for assembly of the ultrasound transducer 6 in the cylinder 1 to allow the ultrasound transducer to be orientated parallel or coaxial to the main axis 35.

For this reason, FIG. 6 shows, as a variant, an ultrasound transducer 6B that is also coupled to an analytical facility 7B. The ultrasound transducer 6B is attached on the side of the cylinder 1 in the area of the front surface thereof, and guides ultrasound signals first radially into the internal space of the cylinder where they are deflected by 90° on a deflecting mirror 42 that serves as deflecting facility such that they subsequently proceed parallel to the main axis 35 in the direction of projection 30B, as is also indicated by the arrow 43.

In addition, a reference surface 44 can be integrated into the deflecting mirror 42 that corresponds to the reference surface 9 described above and can be used for measuring the velocity of sound in the medium.

The transverse-positioned ultrasound transducer 6B and the deflecting mirror 42 allow ultrasound waves to be guided also into a very small annular gap 41 a between the piston rod 3 and the internal wall 33 of the cylinder 1. The ultrasound signals that are reflected from the projection 30B are then guided via the deflecting mirror 42 back to the ultrasound transducer 6B, where the transit time can be determined.

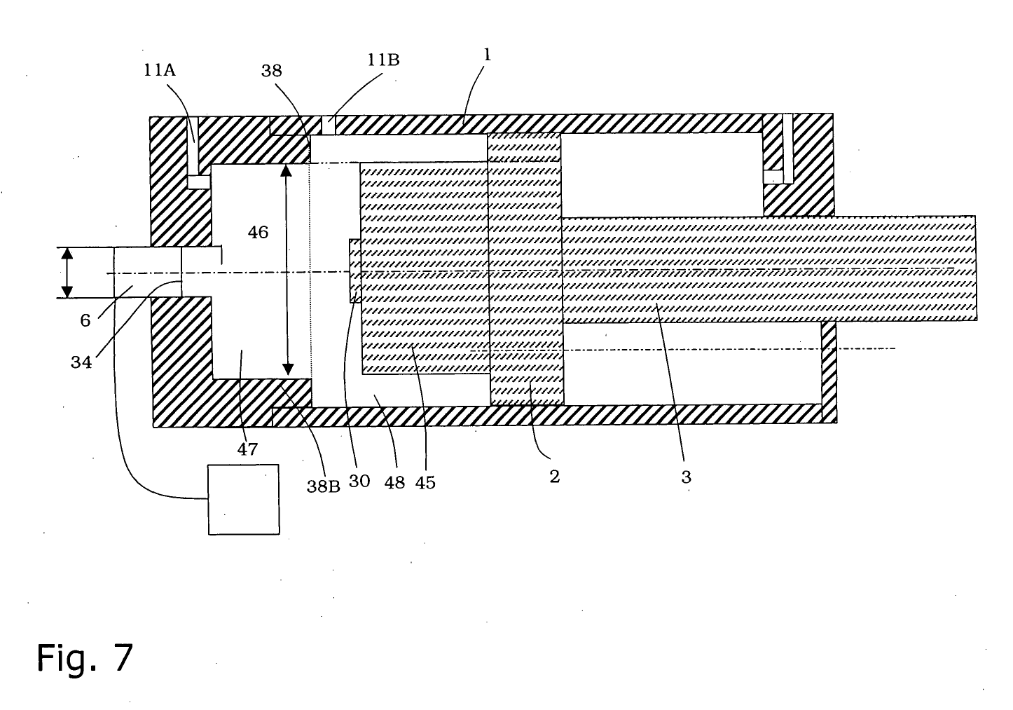

FIG. 7 shows an embodiment, in which a step 45, which in turn carries the projection 30, is provided on the piston 2.

The diameter of the step 45 is matched to an internal diameter 46 of a part-chamber 47 such that the step 45 can penetrate into the part-chamber 47 and, by this means, separates the part-chamber 47 from a main chamber 48 of the cylinder 1. Because of separate lines 11A (leading to part-chamber 47) and 11B (leading to main chamber 48), it is feasible to dampen the motion of the piston 2 shortly before it reaches its front-side end-position (the left end-position in FIG. 7). This is feasible, in particular, when the outflow of oil from the part-chamber 47 via the line 11A can only occur in a delayed fashion.

A prerequisite for this end-position damping, which is described in similar manner in U.S. Pat. No. 4,543,649, to work properly is that the step 45 is matched to the internal diameter 46 of the part-chamber 47 such as to be basically perfectly fitting such that only small amounts of oil can still flow from the part-chamber 47 into the main chamber 48.

The projection 30, though, is raised clearly, and isolated thereby. Between the projection 30 and the external diameter of the step 45, a broad annular gap is provided that facilitates the separation of the projection 30 from internal walls of the cylinder 1 even when the step 45 has penetrated into the part-chamber 47.

In this context, the diameter of the projection 30 must correspond maximally to the internal diameter 46 of the part-chamber 47 minus the diameter of the emitting surface 34 of the ultrasound transducer 6.

Having described preferred embodiments of the invention, it will be apparent to those skilled in the art to which this invention relates, that modifications and amendments to various features and items can be effected and yet still come within the general concept of the invention. It is to be understood that all such modifications and amendments are intended to be included within the scope of the present invention.

1. Device for determining the position of a piston (2) in a cylinder (1) having an ultrasound facility (5) for transmitting ultrasound signals into the inside of the cylinder (1) and for receiving ultrasound signals that are reflected from said piston (2),
whereby
the signals are guided on the inside of the cylinder (1) in a direction essentially perpendicular onto a front surface (4) of the piston (2), and are reflected from there;
a projection (30) is provided on the front surface (4) of the piston (2) and comprises a front surface (31) that is offset by a certain height (32) with respect to the remaining front surface (4) of the piston (2);
the projection (30) is isolated in any piston position that can be reached during operation, such that a lateral surface (31 a) that borders on the front surface (31) of the projection (30) and leads to the front surface (4) of the piston (2) is situated to be free and does not immediately border on an internal surface (33) of the cylinder (1); and
whereby
an analytical facility (7) is present for analyzing a transit time of the ultrasound signals from the ultrasound facility (5) to the front surface (31) of the projection (30) and back to the ultrasound facility (5), and for determining the position of the piston (2) based on said transit time of the ultrasound signals.

2. Device according to claim 1, characterized in that the ultrasound facility (5) comprises an ultrasound transducer (6) for transmitting and receiving the ultrasound signals.

3. Device according to claim 1 or 2, characterized in that the projection (30), in particular the front surface (31) of the projection (30), is provided to be axially symmetrical to a main axis (35) of the piston (2).

4. Device according to any one of the claims 1 to 3, characterized in that the projection (30), in particular the front surface (31) of the projection (30), has a circular or a ring-shaped outline on the remaining front surface (4) of the piston (2).

5. Device according to any one of the claims 1 to 4, characterized in that at least a part of the remaining front surface (4) of the piston (2) surrounds the projection (30) radially on the outside.

6. Device according to any one of the claims 1 to 5, characterized in that the projection (30) is an integral component of the piston (2) or is secured to the remaining piston (2) as a separate structural component.

7. Device according to any one of the claims 1 to 6, characterized in that the diameter (36) of the projection (30) corresponds at least to the diameter (34b) of an effective transmitting surface (34) of the ultrasound transducer (6).

8. Device according to any one of the claims 1 to 7, characterized in that the diameter (36) of the projection (30) corresponds at most to an internal diameter (37) of the cylinder (2) that is decisive for guidance of the piston (2) minus the diameter of the transmitting surface (34) of the ultrasound transducer (6).

9. Device according to any one of the claims 1 to 8, characterized in that the height (32) of the projection (30), namely a distance between the front surface (31) on projection (30) and the remaining front surface (4) of the piston (2), corresponds to at least half of a rise time of the ultrasound signal (16) multiplied by the maximal possible velocity of sound in a medium that is enclosed by the piston (2) and the cylinder (1).

10. Device according to any one of the claims 1 to 9, characterized in that
a stop (38) is provided on the inside (23) of the cylinder (1) for stopping the remaining front surface (4) of the piston (2) and thus for defining an end-position for the piston (2); and in that
the stop (38) is designed such that, when the piston (2) is in the end-position, the part of the remaining front surface (4) of the piston (2) that does not touch the stop (38) contacts the medium.

11. Device according to any one of the claims 1 to 10, characterized in that, with the piston (2) being situated in the end-position, an annular gap (39) is present between the projection (30) and the stop (38), with the annular gap (39) being bordered on one side by a part of the front surface (4) of the piston (2).

12. Device according to any one of the claims 1 to 11, characterized in that
the ultrasound facility (5) is an axial ultrasound facility (6) and is arranged on a front-side end of the cylinder (1); and in that
the ultrasound signals are transmitted essentially axially into the cylinder (1) by the ultrasound transducer (6) of the axial ultrasound facility.

13. Device according to any one of the claims 1 to 12, characterized in that the ultrasound facility (6B) comprises a deflecting facility (42) for deflecting the ultrasound signals transmitted by the ultrasound transducer (6B) toward the front surface (4) of the piston (2) or for deflecting the ultrasound signals reflected from the front surface (4) of the piston (2) back to the ultrasound transducer (6B).

14. Device according to any one of the claims 1 to 13, characterized in that
the ultrasound facility is a transverse ultrasound facility (6B) that is arranged on the side of the cylinder (1);
the transverse ultrasound facility (6B) comprises an ultrasound transducer that is used to transmit the ultrasound signals into the cylinder (1) essentially transversely to a main axis direction (35) of the cylinder (1); and in that
the transverse ultrasound facility (6B) comprises a deflecting facility (42) that is used to deflect the ultrasound signals by an angle of 90 degrees in the direction of the piston (2).

15. Device according to any one of the claims 1 to 14, characterized in that
the piston (2) is connected to a piston rod (3) that is guided axially at a front-side end from the cylinder (1);
the axial ultrasound facility (6) is arranged on a front-side end of the cylinder (1) from which the piston rod (3) is not guided; and in that
the transverse ultrasound facility (6B) is arranged in an area of the front-side end of the cylinder (1), from which the piston rod (3) is guided out.

16. Device according to any one of the claims 1 to 15, characterized in that
the piston (2) is axially mobile in a main chamber (48) of the cylinder (1);
the piston (2) comprises on its front surface (4) a step (45) on which, in turn, the projection (30) is formed; and in that
a part-chamber (47) that borders on the front side on the main chamber (48) is provided in the cylinder (1), with the internal layout of the part-chamber being designed such that the step (45) can penetrate at least partially into the part-chamber (47) and such that the part-chamber (47) thereby becomes separated from the main chamber (48) by the step (45).

17. Device according to any one of the claims 1 to 16, characterized in that
the ultrasound facility (5) comprises a reference surface (9; 44) whose distance to the ultrasound transducer (6) is predefined; and in that
a velocity of sound in the medium can be determined by means of the analytical facility (7) based on the transit time of an ultrasound signal between the ultrasound transducer (6) and the reference surface (9; 44).

18. Device according to claim 17, characterized in that the reference surface (9; 44) and the ultrasound transducer (6) form a structural unit.

19. Device according to claim 17 or 18, characterized in that the reference surface (44) is integrated into the deflecting facility (42).

20. Device for determining the position of a piston (2) in a cylinder (1) having an ultrasound facility (5) for transmitting ultrasound signals into the inside of the cylinder (1) and for receiving ultrasound signals that are reflected from said piston (2),
whereby
the signals are guided on the inside of the cylinder (1) in a direction essentially perpendicular onto a front surface (4) of the piston (2); and whereby
the ultrasound facility (5) comprises a deflecting facility (42) for deflecting the ultrasound signals transmitted by the ultrasound facility (5) toward the front surface (4) of the piston (2) or for deflecting the ultrasound signals reflected from the front surface (4) of the piston (2) back to the ultrasound facility (5).

21. Device according to claim 20, characterized in that the deflecting facility (42) is designed such that the ultrasound signals are deflected by an angle of 90 degrees.
